(19) United States
(12) Patent Application Publication
(10) Pub. No.: US 2026/0250099 A1
(43) Pub. Date: Aug. 27, 2026

(54) APPARATUS AND METHOD FOR WRAPPING ROLLED MATERIAL ON CYLINDRICAL OBJECTS

(71) Applicant: FT Holdings Inc., Calgary (CA)

(72) Inventor: Hewson Charles ELLIOTT, Calgary (CA)

(73) Assignee: FT Holdings Inc., Calgary, AB (CA)

(21) Appl. No.: 18/992,039

(22) PCT Filed: Jul. 7, 2023
(86) PCT No.: PCT/CA2023/050919

§ 371 Date: Jan. 7, 2025

Related U.S. Application Data
(60) Provisional application No. 63/359,298, filed on Jul. 8, 2022.

(51) Int. Cl. B65H 81/06; A62C 3/00

(52) U.S. Cl. CPC B65H 81/06; A62C 3/00; B65H 2301/43824; B65H 2301/515323; B65H 2402/35; B65H 2404/154

(57) ABSTRACT

Apparatus and method are provided for wrapping fire-retardant textile material onto utility poles. The apparatus has a u-shaped frame for placement around the pole and a plurality of pivoting drive wheel assemblies that enclose and engage the pole to support the apparatus. The drive wheel assemblies can move the apparatus circumferentially around the pole as well as move the apparatus axially up and down the pole. Rolled material is dispensed through a cutting and fastening assembly that can fasten a loose end of the rolled material to the pole and then dispense the rolled material about the pole as the apparatus moves circumferentially until the rolled material overlaps the fastened end where the cutting and fastening assembly fastens the material to the pole and then cut the fastened material from the roll. The apparatus can then move axially up or down the pole to place another wrap of the material.

### CROSS-REFERENCE TO RELATED APPLICATIONS

This application claims priority of U.S. provisional patent application Ser. No. 63/359,298 filed Jul. 8, 2022, which is incorporated by reference into this application in its entirety.

### TECHNICAL FIELD

The present disclosure is related to the field of wrapping material, such as rolled material, on cylindrical objects, in particular, for wrapping fire-retardant mesh textile material on utility poles to protect them from fire damage.

### BACKGROUND

Utility poles are used to support electrical power transmission cables, telecommunication cables and other like objects and materials. Utility poles can be made of metal or wood and, as such, are susceptible to damage caused by fires. It is known to wrap utility poles, and the like, with a fire-retardant mesh textile material to aid in preventing fire damage to the poles. The mesh structure of the material is breathable and permits air circulation about the poles through the mesh. Such fire mesh textiles can also be coated with intumescent material or paint that activates and expands or swells at elevated temperatures, such as those caused by fires, to close the openings of the mesh to, therefore, form a solid barrier around the utility pole to prevent excessive fire damage thereto.

Such fire-retardant mesh materials are typically manually installed on utility poles, which can be time-consuming and pain-staking to install the mesh material on the hundreds of utility poles that can form a power transmission, as an example.

It is, therefore, desirable to provide an apparatus and method that can easily install fire-retardant mesh material on a plurality of utility poles in an efficient, timely, and cost-effective manner.

### SUMMARY

An apparatus and method for wrapping rolled material on a cylindrical object is presented. In some embodiments, the apparatus can be used to wrap fire-retardant mesh textile material around the circumference of the cylindrical object. In some embodiments, the cylindrical object can be a utility pole use for supporting electric power transmission cables, telecommunications cables and other like materials and objects. For the purposes of this application, the terms “cylindrical object” and “utility pole” shall be interpreted interchangeably as including all cylindrical or pole-like objects used as structural elements for buildings, structures and any other framework, cable-supporting structures, fabrication elements, or lattice structure supported by or otherwise requiring said cylindrical or pole-like object.

Broadly stated, in some embodiments, an apparatus can be provided for wrapping rolled material on a cylindrical object, the apparatus comprising: a three-dimensional (“3D”) structural frame comprising upper and lower vertices, the 3D structural frame defining an opening disposed therein, the opening configured to receive the cylindrical object, the 3D structural frame further configured to hold a roll of the rolled material thereon; a plurality of pivoting drive wheel assemblies, wherein a pivoting drive wheel assembly is disposed near each of the upper and lower vertices; the 3D structural frame further comprising a clamping arm assembly configured to retain and engage the cylindrical object with the plurality of pivoting drive wheel assemblies; a cutting and fastening assembly linearly coupled to the 3D structural frame, the cutting and fastening assembly configured to: dispense the rolled material from the roll, fasten the dispensed rolled material to the cylindrical object, and cut the dispensed rolled material from the roll; and an electronics assembly disposed on the 3D structural frame, the electronics assembly configured to provide electric power and control signals to the plurality of pivoting drive wheel assemblies, to the clamping arm assembly, and to the cutting and fastening assembly.

Broadly stated, in some embodiments, the 3D structural frame can comprise a roll pole and a roll platform configured to receive and support the roll of rolled material on an end thereof.

Broadly stated, in some embodiments, each of the plurality of pivoting drive wheel assemblies can comprise: a suspension assembly operatively coupling the pivoting drive wheel assembly to the 3D structural frame; a tire operatively coupled to an electric drive motor; a pivot body operatively coupling the tire to the suspension assembly, the pivot body; a wheel pivot axle rotatably disposed in the pivot body, the wheel pivot axle defining a pivot body axis therealong; and a pivot motor operatively coupled to the tire via the wheel pivot axle, wherein operation of the pivot motor enables the tire to rotate about the pivot body axis.

Broadly stated, in some embodiments, the suspension assembly can comprise: a plurality of suspension arms to form a parallelogram structure; and a damper disposed within the parallelogram structure.

Broadly stated, in some embodiments, the pivot motor can be configured to rotate the wheel pivot axle approximately 90° between a first position and a second position, wherein rotation of the tire moves the apparatus circumferentially around the cylindrical object when the wheel pivot axle is in the first position, and wherein rotation of the tire moves the apparatus axially on the cylindrical object along a longitudinal axis thereof when the wheel pivot axle is in the second position.

Broadly stated, in some embodiments, the clamping arm assembly can comprise: at least one actuator arm pivotally attached to the 3D structural frame, wherein each of the at least one actuator arm comprises one of the upper and lower vertices of the 3D structural frame; and a servo actuator operatively coupled between the at least one actuator arm and the 3D structural frame, wherein the servo actuator can move the at least one actuator arm from an open position where the opening can receive the cylindrical object to a closed position where the plurality of pivoting drive wheel assemblies retain and engage the cylindrical object.

Broadly stated, in some embodiments, the cutting and fastening assembly can comprise: a cutting rail servo actuator configured to translate the cutting and fastening assembly towards and away from the cylindrical object; a cutting head assembly further comprising a cutting block head configured to move along a linear guide; a rolled material feed mechanism configured to dispense the rolled material towards the cylindrical object; a fastener gun disposed on the cutting block head, the fastener gun configured to fasten dispensed rolled material to the cylindrical object; and a cutting wheel assembly disposed on the cutting block head, the cutting wheel assembly configured to cut the dispensed rolled material from the roll after the dispensed rolled material is fastened to the cylindrical object.

Broadly stated, in some embodiments, the cutting and fastening assembly can further comprise a lead screw configured to move the cutting block head along the linear guide.

Broadly stated, in some embodiments, the rolled material feed mechanism can further comprise: a material guide configured to guide the rolled material from the roll towards the cylindrical object; and material feed wheels driven by a material feed motor, the material feed wheels configured to contact and move the rolled material through the material guide.

Broadly stated, in some embodiments, the cutting wheel assembly can comprise: a cutting wheel operatively attached to a cutting wheel arm, the cutting wheel arm rotatably attached to the cutting head block; a cutting backing plate disposed on the cutting and fastening assembly; and a cutting wheel servo operatively coupled to the cutting wheel arm whereby operation of the cutting wheel servo moves the cutting wheel towards and away from the cutting backing plate.

Broadly stated, in some embodiments, the electronics assembly can comprise: a computer operatively coupled to each of: the plurality of pivoting drive wheel assemblies, the clamping arm assembly, and the cutting and fastening assembly; at least one battery operatively powering each of: the computer, the plurality of pivoting drive wheel assemblies, the clamping arm assembly, and the cutting and fastening assembly.

Broadly stated, in some embodiments, the electronics assembly can further comprise a radio modem operatively coupled to the computer, the radio modem configured to wirelessly receive command signals transmitted from a ground station controller configured to wirelessly transmit the command signals.

Broadly stated, in some embodiments, a method can be provided for wrapping rolled material on a cylindrical object, the method comprising: placing an apparatus on the cylindrical object, the apparatus comprising: a three-dimensional (“3D”) structural frame comprising upper and lower vertices, the 3D structural frame defining an opening disposed therein, the opening configured to receive the cylindrical object, the 3D structural frame further configured to hold a roll of the rolled material thereon, a plurality of pivoting drive wheel assemblies, wherein a pivoting drive wheel assembly is disposed near each of the upper and lower vertices, the 3D structural frame further comprising a clamping arm assembly configured to retain and engage the cylindrical object with the plurality of pivoting drive wheel assemblies, a cutting and fastening assembly linearly coupled to the 3D structural frame, the cutting and fastening assembly configured to dispense the rolled material from the roll, to fasten the dispensed rolled material to the cylindrical object, and to cut the dispensed rolled material from the roll; closing the clamping arm assembly to retain and engage the cylindrical object with the plurality of pivoting drive wheel assemblies; loading the roll of rolled material onto the apparatus; rotating all of the plurality of pivoting drive wheel assemblies for axial movement along the cylindrical object; moving the apparatus along the cylindrical object to a predetermined position; rotating all of the plurality of pivoting drive wheel assemblies for circumferential movement around the cylindrical object; moving the cutting and fastening assembly towards the cylindrical object and dispensing a loose end of the rolled material from the roll towards the cylindrical object; fastening the loose end of the rolled material to the cylindrical object; moving the apparatus around the cylindrical object and dispensing the rolled material to wrap the cylindrical object a predetermined number of times with the rolled material; and simultaneously cutting the dispensed rolled material to produce a trailing loose end thereof and fastening the trailing loose end of the dispensed rolled material to the cylindrical object.

### BRIEF DESCRIPTION OF THE DRAWINGS

FIG. 1 is a front isometric view depicting one embodiment of an apparatus for wrapping rolled material onto utility poles.

FIG. 2 is a rear isometric view depicting the apparatus of FIG. 1.

FIG. 3 is a top plan view depicting the apparatus of FIG. 1 being placed onto a utility pole.

FIG. 4 is a top plan view depicting the apparatus of FIG. 3 positioned onto the utility pole.

FIG. 5 is a top plan view depicting an actuator arm of the apparatus of FIG. 3 in an open position.

FIG. 6 is a top plan view depicting an actuator arm of the apparatus of FIG. 4 in a closed position.

FIG. 7 is an isometric view depicting the apparatus of FIG. 4 configured for movement circumferentially around the utility pole.

FIG. 8 is an isometric view depicting the apparatus of FIG. 7 configured for movement axially up and down the utility pole.

FIG. 9 is a top plan view depicting the apparatus of FIG. 7 with its pivoting drive wheel assemblies configured to move the apparatus circumferentially around an obstacle disposed on the utility pole.

FIG. 10 is a top plan section view depicting the apparatus of FIG. 7 with the rolled material fed into the apparatus for being wrapped on the utility pole.

FIG. 11 is a top plan view depicting the cutting and fastening assembly of the apparatus of FIG. 10.

FIG. 12 is an isometric view depicting a driving wheel assembly of the apparatus of FIG. 7, the assembly in a circumferential driving configuration.

FIG. 13 is an isometric view depicting the driving wheel assembly of FIG. 12 in an axial driving configuration.

FIG. 14 is a top plan section view depicting the driving wheel assembly of FIG. 13.

FIG. 15 is a front elevation view depicting the driving wheel assembly of FIG. 12 with components removed to illustrate the internal mechanism thereof.

FIG. 16 is a front isometric view depicting the cutting and fastening assembly of the apparatus of FIG. 1.

FIG. 17 is a rear isometric view depicting the cutting and fastening assembly of the apparatus of FIG. 16.

FIG. 18 is a top plan section view depicting the cutting and fastening assembly of FIG. 11 with the cutting wheel in a raised position.

FIG. 19 is a detailed top plan view depicting the cutting and fastening assembly of FIG. 18.

FIG. 20 is a side elevation view depicting the cutting wheel of the cutting and fastening assembly of FIG. 18 in a retracted position.

FIG. 21 is a side elevation view depicting the cutting wheel of the cutting and fastening assembly of FIG. 18 in an extended position.

FIG. 22 is an isometric view depicting the roll pole of the apparatus of FIG. 1.

FIG. 23 is an isometric view depicting the roll pole of FIG. 22 disposed in the apparatus of FIG. 1.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently-disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently-disclosed subject matter.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently-disclosed subject matter.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

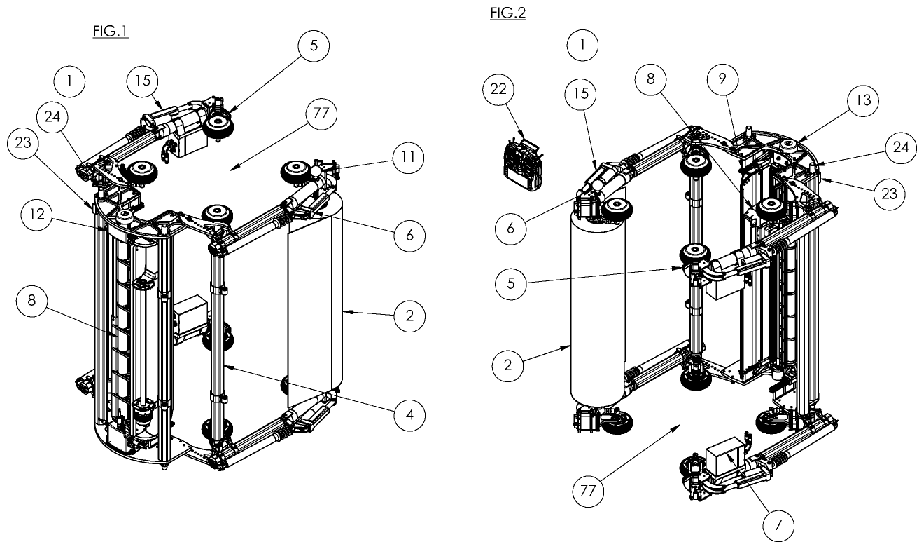

Referring to FIGS. 1 to 23, embodiments of an apparatus and method for wrapping rolled material on a cylindrical object are presented. In some embodiments, the apparatus can comprise of a pole wrapping robot configured for wrapping fire-retardant mesh textile around the circumference of utility poles.

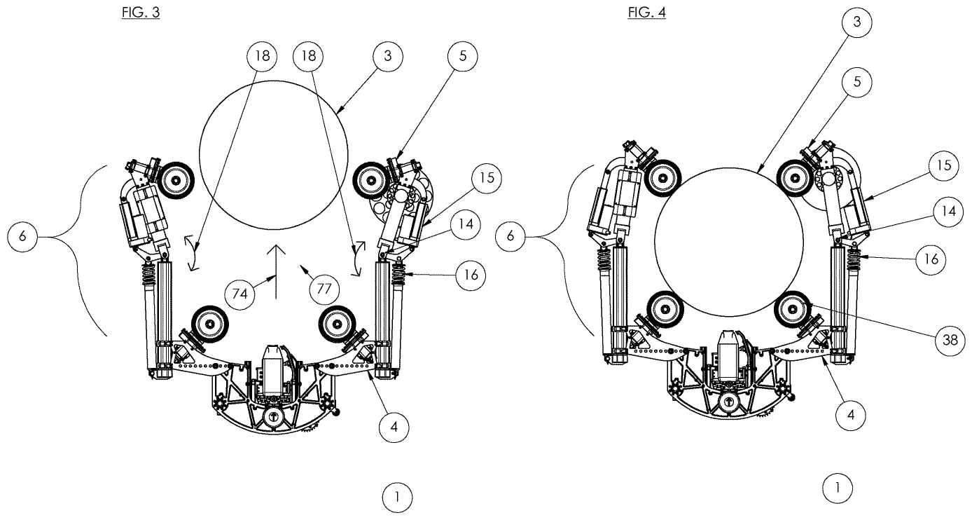

FIG. 1 shows a front isometric view of one embodiment of an apparatus for wrapping rolled material onto a cylindrical object such as a utility pole, which shall be referred to in this description as pole wrapping robot [1] or simply robot [1]. FIG. 2 shows a rear isometric view of robot [1] that can install, or wrap rolled material [2] onto cylindrical objects of varying diameters in specific locations automatically or as a user commands. In some embodiments, robot [1] can comprise of three-dimensional structural frame [4], a plurality of pivoting drive wheel assemblies [5], a plurality of actuator arms [6], a plurality of batteries [7] operatively coupled to electrical and electronic components disposed on robot [1] and configured to provide electrical power thereto, cutting and fastening assembly [8] that can be disposed on radial rails [9], roll pole [11], central computing module [12], and global positioning system (“GPS”) Antenna [13]. In some embodiments, the batteries, electrical and electronic components of robot [1] described herein can be operatively coupled together to form an electronics assembly to provide electric power and control signals to one or more of pivoting drive wheel assemblies [5], actuator arms [6], cutting and fastening assembly [8], central computing module [12], GPS antenna [13], linear actuators [15], radio module [23], radio antenna [24], cutting rail servos [25], stapling device or fastener gun [26], wheel motor assembly [38], wheel motors [44], pivot servo [46], cutting head assembly [52], lead screw servo [54], material feed motor [60], and cutting servo [70].

To operate robot [1], a human operator can use ground station [22] to send radio signals to one or more radio antennas [24], which can be operatively connected to radio module [23] that can decode the radio signals from ground station [22] and sends these signals to central computing module [12], which in turn can send signals to the electrical and electronic equipment fitted to robot [1], for example, its electrically driven wheels and linear actuators [15]. This can enable robot [1] to install rolled material [2] onto cylindrical surfaces such as utility poles [3]. In some embodiments, central computing module [12] can be programmed to operate robot [1] automatically without operator input or semi-automatically by taking cues from the human operator via ground station [22] as desired. In some embodiments, ground station [22] can comprise a Herelink model transmitter manufactured by CubePilot company of Moolap, Australia.

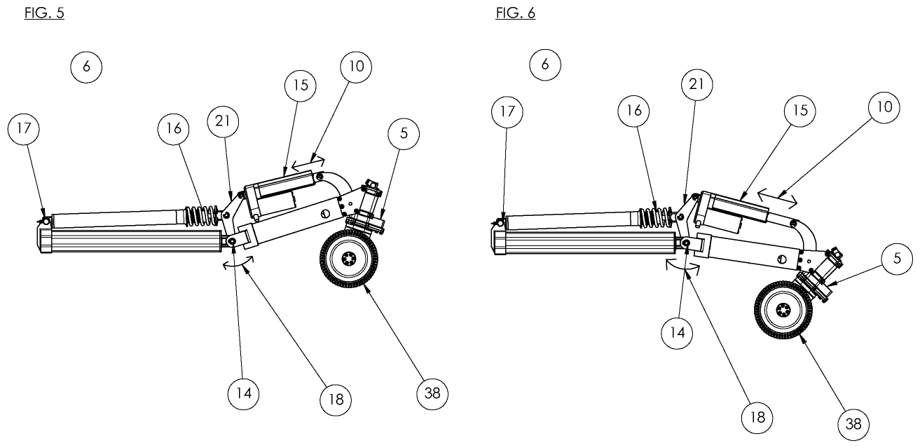

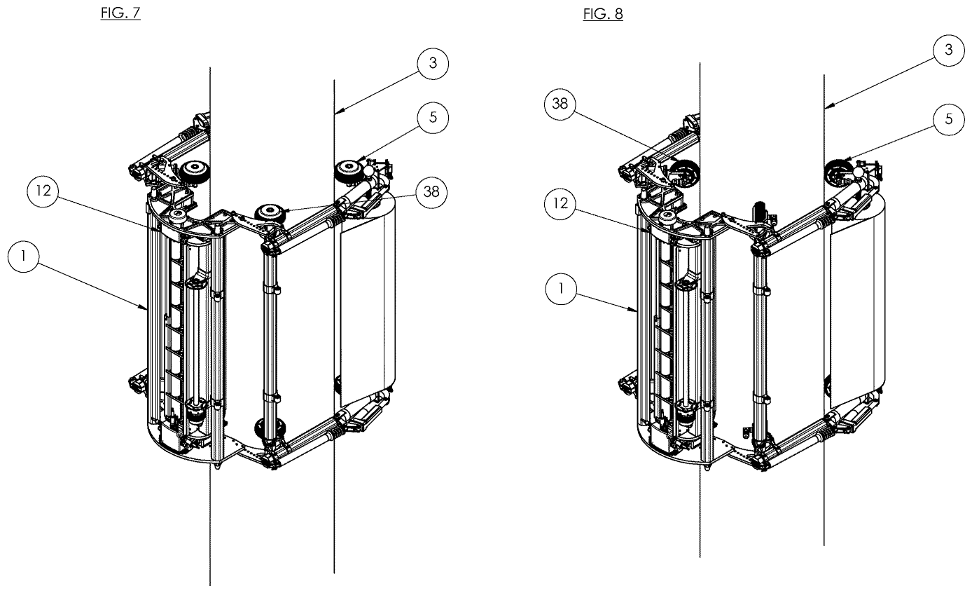

FIG. 3 depicts a top plan view of robot [1] prepared to approach a cylindrical surface such as utility pole [3], as it moves along a path indicated by direction arrow [78], with a plurality of open actuator arms [6], which can be part of a clamping arm assembly configured to retain and engage cylindrical objects, such as utility pole [3], with the plurality of pivoting drive wheel assemblies [5]. FIG. 4 depicts a top plan view of robot [1] clamped onto utility pole [3] with the plurality of actuator arms [6] in their closed state. To mount robot [1] onto utility pole [3], linear actuators [15] on actuator arms [6] can retract along direction arrow [10] (as shown in FIGS. 5 and 6), causing a rotation along direction arrow [18] about arm pivot [14]. This can allow outer pivoting drive wheel assemblies [5] to open outwards, creating sufficient space for the incoming utility pole [3]. Once utility pole [3] has entered opening [77] of robot [1], utility pole [3] will stop once it has met the pivoting drive wheel assemblies [5] that are affixed to structural frame [4]. To secure robot [1] to utility pole [3], linear actuators [15] can extend to pivot the outer pivoting drive wheel assemblies [5] inwards to contact utility pole [3]. This action can apply sufficient force to each of the plurality of pivoting drive wheel assemblies [5] to substantially compress suspension assemblies [16] thereof, ensuring traction for robot [1] to maintain its position on utility pole [3] and to traverse therearound to wrap rolled material thereto.

FIG. 5 and FIG. 6 show actuator arm [6] in its open and closed position, respectively. In some embodiments, actuator arm [6] can comprise of pivoting drive wheel assembly [5], arm pivot [14], linear actuator [15], suspension assembly [16], load cell [17], rocker arm [21], and wheel motor assembly [38]. In some embodiments, actuator arm [6] can adjust to variations in the size of utility pole [3] by varying the length of linear actuator [15] along arm extension axis [10], causing rotation about pivot [14] depicted by arrow [18] while in contact with the surface of utility pole [3]. The length variation of linear actuator [15] can be translated into compression of suspension assembly [16] through rocker arm [21]. The force through suspension assembly [16] can be applied to load cell [17], providing a means to control the force applied to the surface of utility pole [3]. Load cell [17] can be operatively coupled to central computing module [12] to provide feedback as to the force being applied to utility pole [3] by pivoting drive wheel assemblies [5].

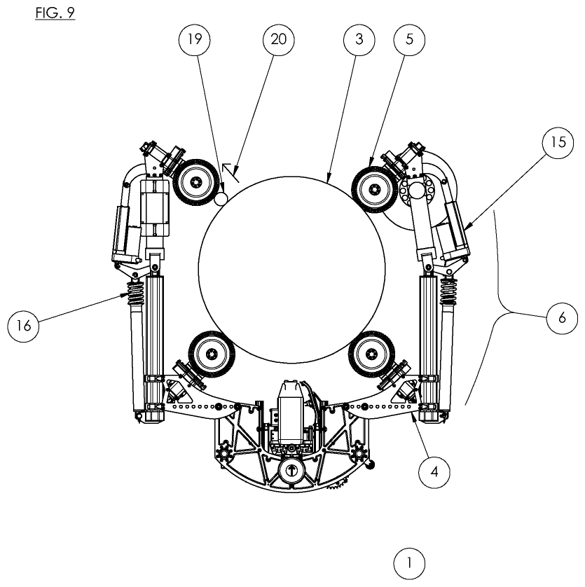

FIG. 7 and FIG. 8 depict an isometric view of robot [1] with its plurality of pivoting drive wheel assemblies [5] in the annular and axial orientation, respectively. In some embodiments, the plurality of pivoting drive wheel assemblies [5] can be commanded to any position between these two states or orientations by central computing module [12], driven by pivot servo [46], which allows robot [1] to traverse utility pole [3] in any direction. During a typical material installation, once robot [1] has been clamped onto utility pole [3], the plurality of pivoting drive wheel assemblies [5] can be commanded to the axial position shown in FIG. 8. In this position, robot [1] can then traverse up or down utility pole [3] a programmed distance by controlling the plurality of wheel motors assemblies [38] to rotate until the desired position is reached. To begin the material installation, the plurality of pivoting drive wheel assemblies [5] can be commanded to rotate their annular position.

FIG. 9 depicts robot [1] traversing an obstacle [19] disposed on utility pole [3]. In some embodiments, the plurality of independent actuator arms [6] that comprise suspension assemblies [16] can allow for enough suspension deflection along direction arrow [20] to traverse obstacles [19] on utility pole [3] all the while keeping all pivoting wheel assemblies [5] in contact with utility pole [3] surface to maintain traction thereto. In some embodiments, suspension assemblies [16] can respond to obstacles [19] on utility pole [3] surface faster than linear actuators [15] to ensure stable performance. In some embodiments, the configuration of structural frame [4] can allow robot [1] to traverse obstacles [19] in both the radial and axial directions relative to utility pole [3], ensuring the flexibility of operable environments.

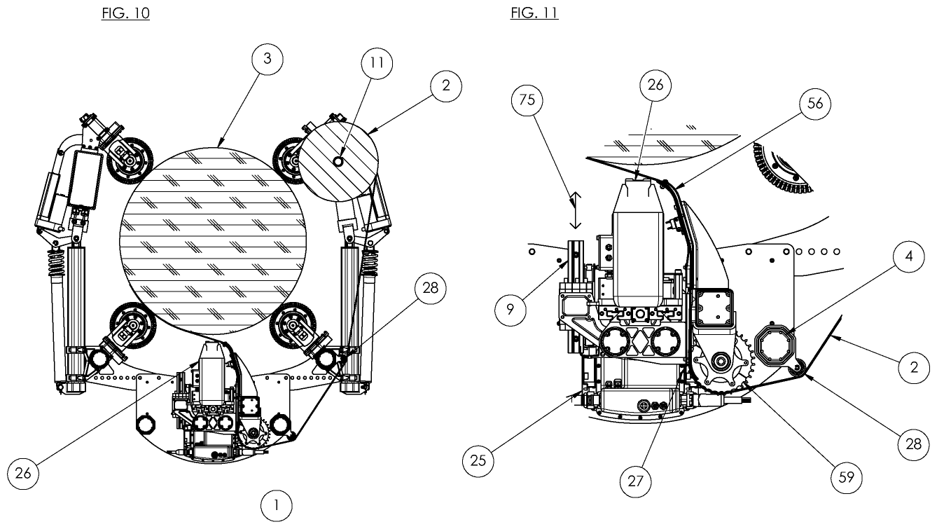

FIG. 10 depicts an overall section view of robot [1] showing cutting and fastening assembly [8] mounted to structural frame [4], including rolled material [2] routed from roll pole [11] through cutting and fastening assembly [8] onto the surface of utility pole [3]. FIG. 11 shows a detailed section view of cutting and fastening assembly [8] with the path of rolled material [2] shown. Rolled material [2] can be driven by a plurality of material feed wheels [59] and can be guided along its path by material guides [27], final material deflector [56], and material rollers [28]. Material guides [27] and final material deflector [56] can constrain rolled material [2] until it is dispensed beyond the tip of stapling device or fastener gun [26]. In some embodiments, cutting and fastening assembly [8] can be attached to structural frame [4] by radial rails [9], which can function to guide cutting and fastening assembly [8] closer or further from the surface of utility pole [3] along direction arrow [75]. In some embodiments, the movement of cutting and fastening assembly [8] to and from the surface of utility pole [3] can be controlled by cutting rail servos [25] through solid linkages. When the feeding operation of rolled material [2] is commanded during a typical process, cutting rail servos [25] can shift to a specified position, thus moving cutting and fastening assembly [8] along radial rails [9] such that the tip of stapling device or fastener gun [26] is near to but not touching the surface of utility pole [3]. This can allow the controlled dispensing of rolled material [2] directly onto the surface of utility pole [3]. Once dispensing of rolled material [2] is complete, cutting rail servos [25] can alter their position along radial rails [9] to bring the tip of stapling device or fastener gun [26] in contact with the surface of utility pole [3] whereby stapling device or fastener gun [26] can fasten the applied rolled material [2] to utility pole [3] with staples. This process can allow for properly fastening of rolled material [2] to utility pole [3] when robot [1] is so commanded or preprogrammed to do so.

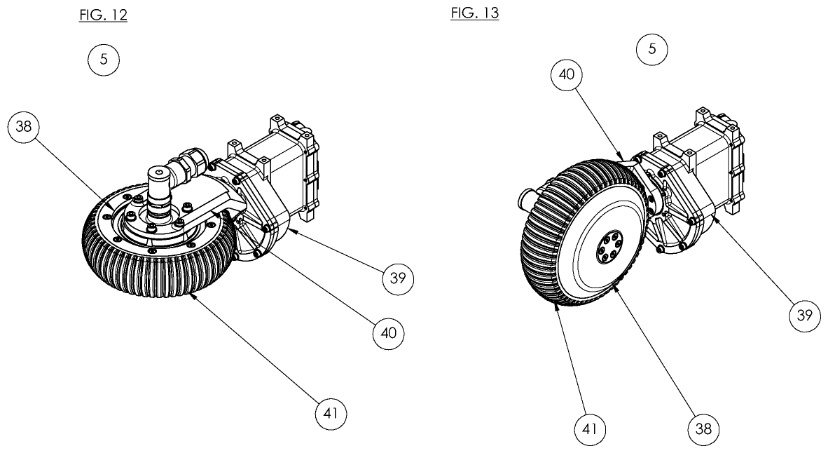

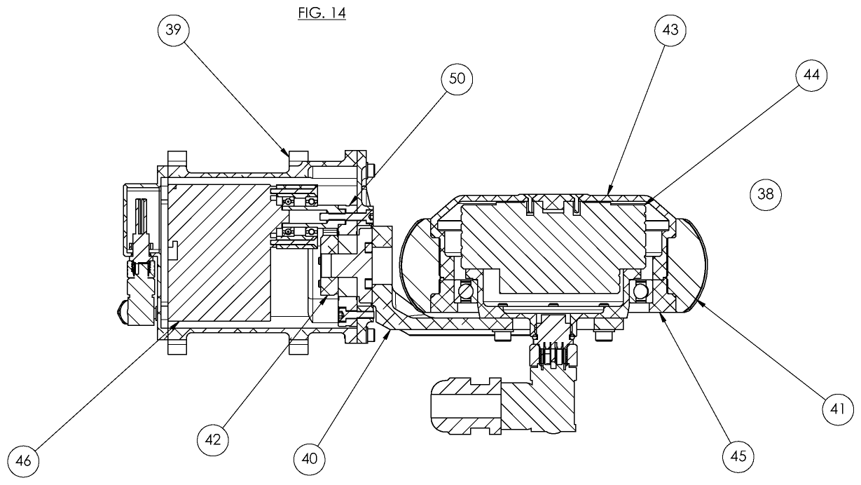

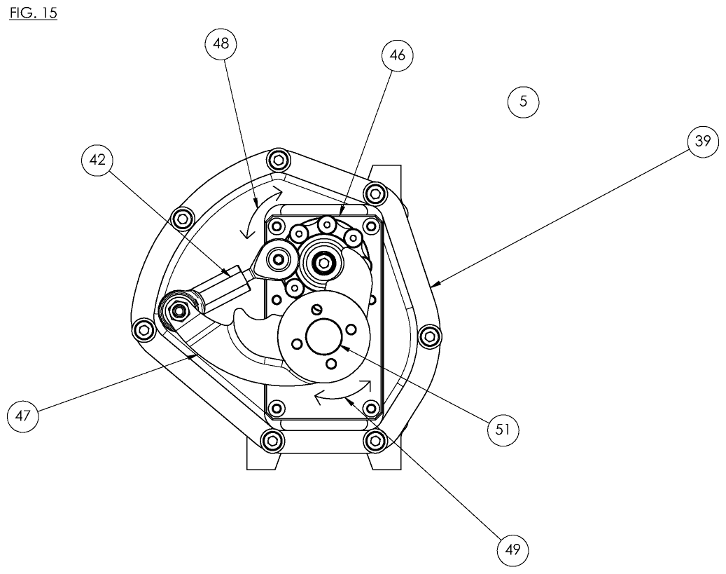

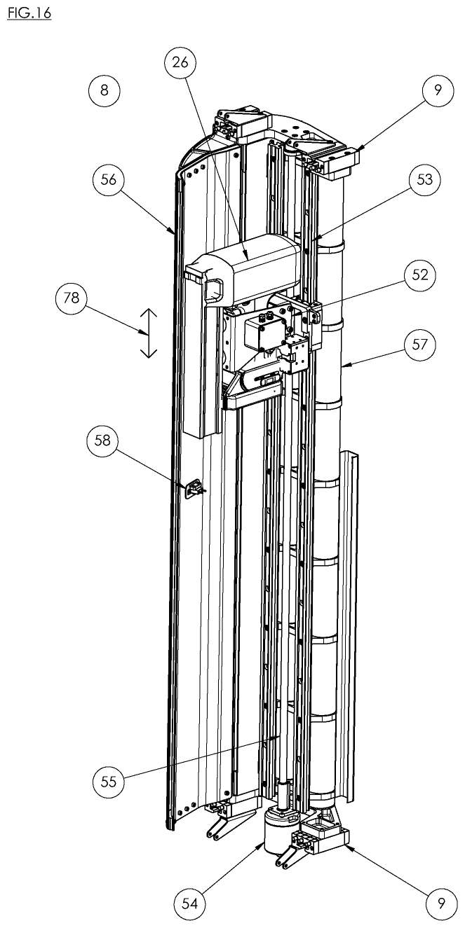

FIGS. 12 and 13 show detailed isometric front views of one embodiment of the driving wheel assembly in axial and radial orientation. In some embodiments, pivoting drive wheel assembly [5] can comprise of wheel tread [41], wheel motor assembly [38], wheel arm [40], pivot servo [46], pivot linkage arm [47], pivot linkage [42], and pivot drive housing [39]. In some embodiments, pivot drive housing [39] can be rigidly mounted to actuator arms [6], and to structural frame [4] depending on its location on robot [1]. In some embodiments, wheel arm [40] can be substantially supported by pivot drive housing [39] with pivot support bearing [50] as shown in FIG. 14. In some embodiments, pivot support bearing [50] can be configured with a crossed roller geometry to restrict rotational motion to only one axis, as understood by those skilled in the art.

FIG. 14 shows a detailed section view of one embodiment of pivoting drive wheel assembly [5] in the annular driving configuration. In some embodiments, wheel motor assembly [38] can comprise of wheel motor [44], wheel support bearing [45], and wheel housing [43]. In some embodiments, wheel motor [44] output can be rigidly connected to wheel housing [43], while the body of wheel motor [44] can be rigidly fixed to wheel arm [40]. Wheel housing [43] can also be connected to wheel arm [40] by wheel support bearing [45] to transfer high loads from wheel housing [43] into wheel arm [40]. In some embodiments, wheel tread [41] can be comprised of elastomeric material bonded to wheel housing [43] such that the rotation of wheel housing [43] is translated into rotation of wheel tread [41].

FIG. 15 depicts a front view of one embodiment of pivoting drive wheel assembly [5] with components removed for a view of the internal mechanism. Within the assembly, pivoting drive wheel assembly [5] can comprise pivot servo [46], pivot linkage arm [47], pivot linkage [42], and pivot axle [51]. When pivot servo [46] output is rotated about direction arrow [48], the movement can be translated through pivot linkage [42] and pivot linkage arm [47], resulting in rotation of pivot axle [51] about direction arrow [49]. Torque applied to pivot axle [51] by pivot servo [46] can be amplified through the linkage, which can contribute to the operational efficacy of robot [1]. Given the constraints related to spatial limitations and the power capabilities of pivot servo [46], the servo must not be required to undergo substantial rotational torque to achieve rotation of pivot axle [51] while wheel tread [41] is under load.

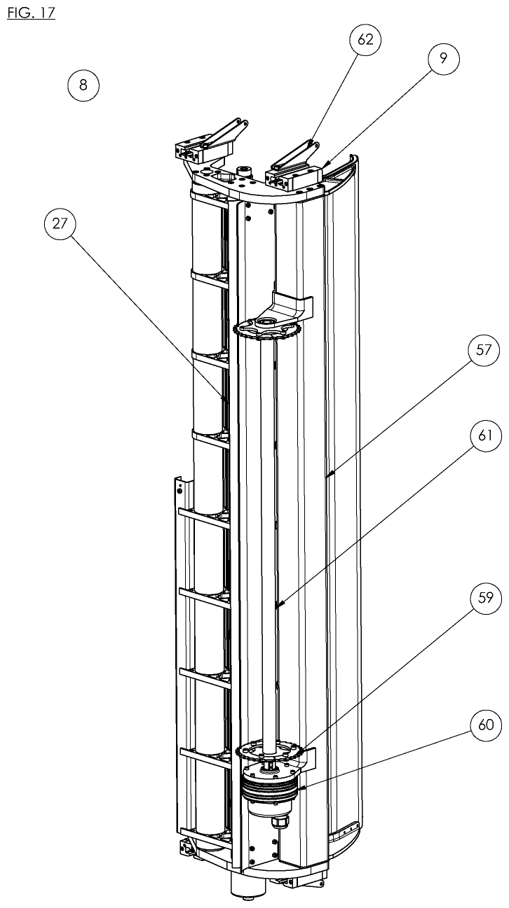

FIG. 16 displays a front isometric view of one embodiment of cutting and fastening assembly [8] comprising of fastener gun [26], cutting head assembly [52], linear guides [53], lead screw servo [54], lead screw [55], final material deflector [56], cutting structure [57], material switch [58], and radial rails [9]. FIG. 17 depicts a rear isometric view of cutting and fastening assembly [8], illustrating material feed motor [60], a plurality of material feed wheels [59], the material feed rod [61], and the material guide [27]. Both of FIGS. 16 and 17 also depict a plurality of radial servo clevis [62] and radial rails [9], which can allow cutting and fastening assembly [8] to move towards and away from the surface of utility pole [3]. In some embodiments, cutting head assembly [52] can be mounted on linear guide [53], which can restrict the motion of cutting head assembly [52] to a single axial direction as shown by direction arrow [78]. The linear motion can be constrained by lead screw [55], which can impart linear motion directly when lead screw [55] is rotated, as known by those skilled in the art. In some embodiments, lead screw [55] can be directly coupled to lead screw servo [54] such that rotation of lead screw servo [54] can impart rotation to lead screw [55]. Thus, the position of cutting head assembly [52] can be directly coupled to the rotation of lead screw servo [54]. In some embodiments, the rotation of lead screw servo [54] can be commanded to the position by central computing module [12] as required by the installation sequence.

FIG. 18 depicts a section view of one embodiment of cutting and fastening assembly [8] with cutting wheel [63] raised. Under regular operation, rolled material [2] can be partially unrolled with the loose end thereof being fed into material guide [27]. When the loose end of rolled material [2] is pulled through the plurality of material feed wheel [59] and reaches material switch [58], robot [1] is considered to be loaded with rolled material [2], and the unraveling sequence can be automated henceforth by central computing module [12]. In some embodiments, the path of rolled material [2] within cutting and fastening assembly [8] can be fully constrained such that when material feed wheels [59] rotate, the motion is directly translated to rolled material [2] through the assembly. In some embodiments, material feed wheels [59] can be directly coupled to material feed motor [60] and material feed rod [61] such that rotation of material feed motor [60], when or as commanded by central computing module [12], can directly translate to the rotation of the plurality of material feed wheels [59]. Rolled material [2] can then be directed by final material deflector [56] past fastener fun [26] toward utility pole [3] to ensure no snags are impeding the motion of rolled material [2]. This can allow the amount of rolled material [2] that is dispensed by cutting and fastening assembly [8] to be precisely controlled by central computing module [12] and automated as required by the installation sequence.

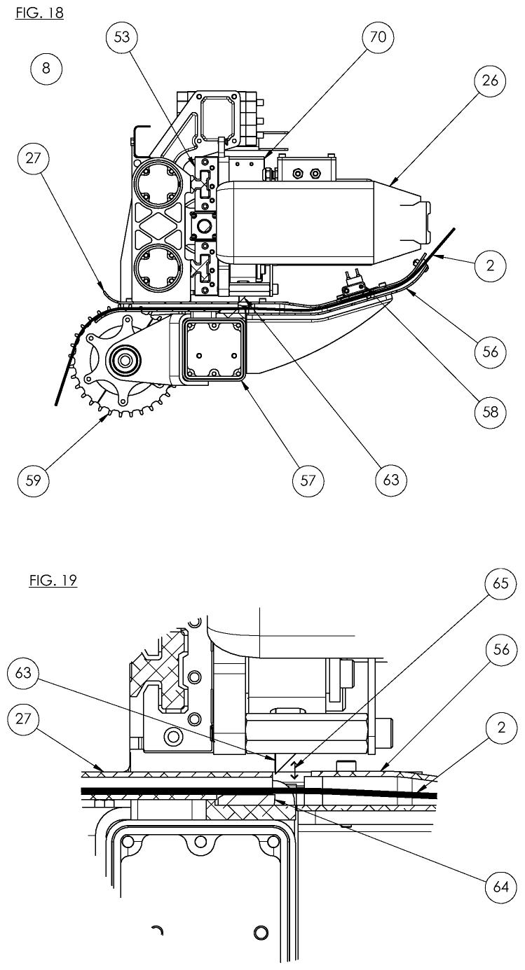

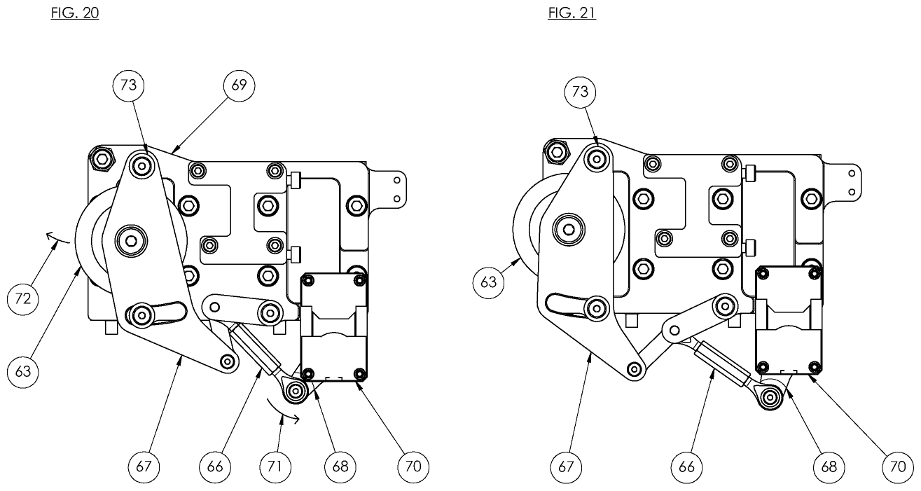

FIG. 19 is a detailed view of a section view of one embodiment of cutting and fastening assembly [8], which illustrates cutting wheel [63], cutting backing [64], material guide [27], and final material deflector [56] with rolled material [2] fed therethrough. A gap between material guide [27] and final material deflector [56] can be configured to allow for the insertion of cutting wheel [63]. In the illustrated embodiment, cutting wheel [63] is shown raised such that it substantially clears the passage that rolled material [2] passes through, preventing restriction to rolled material [2] during the feeding operation. When cutting of rolled material [2] is desired, central computing module [12] can command cutting servo [70] to rotate such that cutting wheel [63] is lowered substantially past cutting backing [64], shown by wheel movement arrow [65]. The sharp edge of cutting wheel [63] can then apply a rolling shearing force to rolled material [2] against cutting backing [64], which can be mechanically bonded to cutting structure [57], causing rolled material [2] to be cut as known by those skilled in the art. Cutting head assembly [52] can then traverse the length of cutting and fastening assembly [8], thereby cutting rolled material [2].

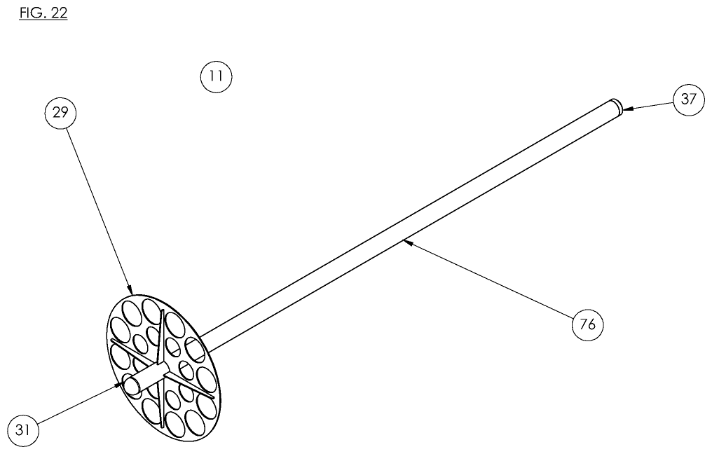

FIGS. 20 and 21 show detailed views of cutting head assembly [52] with cutting wheel [63] in raised (or retracted) and lowered (or extended) positions, respectively. Some components cutting head assembly [52] have been removed from these figures for clarity. In some embodiments, cutting head assembly [52] can comprise of cutting head block [69], cutting servo [70], cutting servo arm [68], cutting toggle linkage [66], cutting wheel arm [67], and cutting wheel [63]. In some embodiments, cutting wheel [63] can be positionally located by its bearing support in cutting wheel arm [67] but can be allowed to rotate freely. In some embodiments, the position of cutting wheel [63] can be controlled by the rotation of cutting wheel arm [67] about cutting wheel arm pivot [73]. In some embodiments, cutting wheel arm [67] can be operatively connected to cutting servo arm [68] through cutting toggle linkage [66] such that the rotation of cutting servo [68] output about direction arrow [71], which can be operatively connected to the Cutting Servo Arm [70], can cause cutting wheel arm [67] to rotate about direction arrow [72], as commanded by central computing module [12]. In some embodiments, cutting toggle linkage [66] can be configured such that the forces applied by cutting wheel arm [67] can be distributed through cutting head block [69] rather than cutting servo [70]. In some embodiments, the range of motion of cutting wheel arm [67] rotation can allow cutting wheel [63] to move fully clear of the path of material guide [27] such that rolled material [2] does not become caught on cutting wheel [63] during the material feeding operations.

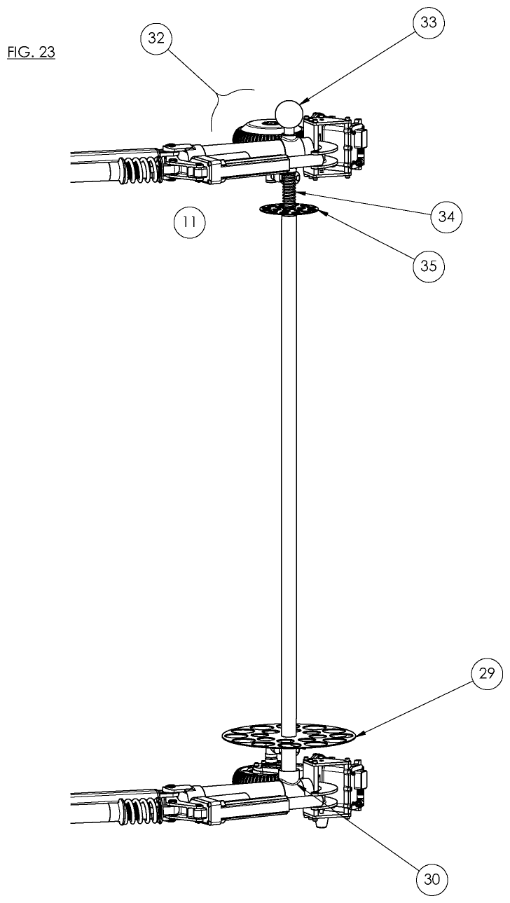

FIG. 22 illustrates a forward isometric view of one embodiment of roll pole [11]. In some embodiments, roll pole [11] can comprise of lower roll platform [29], lower ball end [31], roll pole frame [76], and upper cup point [37]. FIG. 23 illustrates roll pole [11] positioned within robot [1]. In some embodiments, rolled material [2] can be loaded onto roll pole [11], which can then be restrained and supported by roll platform [29]. In some embodiments, roll pole [11] can comprise spherical joints and can be operatively affixed to structural frame [4] of robot [1] by inserting lower ball end [31] into receiving inlet [30] disposed on structural frame [4], thereby creating a ball joint. This lower ball joint can enable roll pole [11] to adjust for any variations in the positioning of actuator arms [6] disposed at the top and bottom of robot [1].

Once lower ball end [31] has been inserted into receiving inlet [30], the upper part of roll pole [11] can be slotted into roll latch [32]. In some embodiments, this latch can comprise a plunger mechanism to ensure the secure and adjustable placement of roll pole [11]. In some embodiments, the plunger mechanism can comprise spherical handle [33], spring receiver [34], and top roll platform [35]. Upon pulling spherical handle [33], spring receiver [34] can contract, storing potential energy. Once roll pole [11] is positioned appropriately within robot [1], spherical handle [33] can be released, and spring receiver [34] can force ball end [36] of spring receiver [34] into upper cup point [37] of roll pole [11]. This can stabilize the placement of roll pole [11] between the two formed ball joints ensuring substantial maneuverability.

### EXAMPLE

In some embodiments, robot [1] can install any flexible rolled material [2] onto utility pole [3] or any other cylindrical object in any orientation. The following describes a possible installation sequence for installing fire-resistant mesh as the rolled material onto a utility pole.

In some embodiments, the installation sequence can begin with workers moving robot [1] into position for placement on utility pole [3] with clamping arm assemblies [27] in an open position. Once robot [1] is in place, actuator arms [6] can close around utility pole [3] securely placing robot [1] thereon with the plurality of wheel treads [41] in contact with the surface of utility pole [3]. The workers can then load robot [1] with a roll of fire-resistant mesh as rolled material [2] onto roll pole [11] as described above. In some embodiments, robot [1] can then command the plurality of pivoting drive wheel assemblies [5] to rotate to their axial translation position. The plurality of wheel motors [44] can then be commanded to rotate, thereby causing robot [1] to climb vertically up utility pole [3]. Once the desired vertical position is reached, as measured by an internal encoder disposed within wheel motor [44], the plurality of pivoting drive wheel assemblies [5] can be commanded to rotate back to their radial translation positions, thereby holding robot [1] onto utility pole [3] at this elevation. Cutting rail servos [25] can then be commanded to extend to the position that shifts cutting and fastening assembly [8] into an initial material feeding phase position close to but not contacting utility pole [3]. Material feed motor [60] can then be commanded to rotate, pushing rolled material [3] through cutting and fastening assembly [8] and out the end of final material deflector [56] onto the surface of utility pole [3] while the plurality of wheel motors [44] are simultaneously commanded to rotate slowly, ensuring the mesh material is placed or wrapped around the surface of utility pole [3] surface without interruption. Once a predetermined amount of mesh has been dispensed onto the surface of utility pole [3], wheel motors [44] can be commanded to stop rotating, and material feed motor [60] can be commanded to stop feeding rolled material [2] through cutting and fastening assembly [8]. Lead screw servo [54] can then be commanded to rotate until cutting head assembly [52] is in the location of the first fastener installation. Cutting rail servos [25] can then be commanded to extend so that the tip of fastener gun [26] disposed on cutting head assembly [52] meets the surface of utility pole [3]. When the tip of fastener gun [26] is in contact with utility pole [3], fastener gun [26] can be commanded to drive a fastener through the dispense rolled material [2] into utility pole [3], securing rolled material [2] in place. Cutting rail servos [25] can then be commanded to retract back so that the tip of fastener gun [19] is no longer in contact with utility pole [3]. Lead screw servo [54] can then be commanded to rotate, positioning cutting head assembly [52] at the location of the next fastener installation. The process can be repeated until the programmed number of fasteners has been installed and rolled material [2] is secured. Once the loose end of rolled material [2] has been secured to utility pole [3], wheel motors [44] can be commanded to rotate. This causes robot [1] to translate around the circumference of utility pole [3] while simultaneously commanding material feed motor [60] to apply a retractive torque that can hold rolled material [2] tight to the surface of utility pole [3]. Once robot [1] has completed the programmed number of rotations around the circumference of utility pole [3], wheel motors [44] can be commanded to stop rotating. Lead screw servo [54] can then be commanded to rotate to position cutting head assembly [52] at an uppermost position. Cutting servo [70] can then be commanded to rotate, moving cutting wheel [63] into a cutting position. Lead screw servo [54] can then be commanded to rotate, moving cutting head assembly [52] down linear guide [53] thereby cutting rolled material [2]. As cutting head assembly [52] cuts rolled material [2], cutting rail servos [25] can be simultaneously commanded to extend, bringing the tip of fastener gun [26] near utility pole [3]. Fastener gun [26] can then be commanded to drive fasteners into utility pole [3] at programmed locations to ensure the cut end of rolled material [2] stays firmly fastened to utility pole [3]. Pivoting drive wheel assemblies [5] can then be commanded to rotate to their axial translation position. Wheel motors [44] can then be commanded to rotate, lowering robot [1] to the next programmed installation position for rolled material [2] and repeating the installation process of rolled material [2] as described above. This sequence can be repeated until the desired amount of the surface of utility pole [3] is covered with rolled material [2]. When robot [1] has completed the installation procedure of rolled material [2], workers can remove robot [1] it from utility pole [3] as actuator arms [6] open. As per this example, utility pole [3] is now successfully covered with the desired fire mesh material.

A similar process can be done to cover any other cylindrical surface with Rolled Material [2] sequentially, such as in the example above, or in a continuous spiral manner as desired and programmed by the installer.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An apparatus for wrapping rolled material on a cylindrical object, the apparatus comprising:
a) a three-dimensional (“3D”) structural frame comprising upper and lower vertices, the 3D structural frame defining an opening disposed therein, the opening configured to receive the cylindrical object, the 3D structural frame further configured to hold a roll of the rolled material thereon;
b) a plurality of pivoting drive wheel assemblies, wherein a pivoting drive wheel assembly is disposed near each of the upper and lower vertices;
c) the 3D structural frame further comprising a clamping arm assembly configured to retain and engage the cylindrical object with the plurality of pivoting drive wheel assemblies;
d) a cutting and fastening assembly linearly coupled to the 3D structural frame, the cutting and fastening assembly configured to:
i) dispense the rolled material from the roll,
ii) fasten the dispensed rolled material to the cylindrical object, and
iii) cut the dispensed rolled material from the roll; and
e) an electronics assembly disposed on the 3D structural frame, the electronics assembly configured to provide electric power and control signals to the plurality of pivoting drive wheel assemblies, to the clamping arm assembly, and to the cutting and fastening assembly.

2. The apparatus as set forth in claim 1, wherein the 3D structural frame comprises a roll pole and a roll platform configured to receive and support the roll of rolled material on an end thereof.

3. The apparatus as set forth in claim 1, wherein each of the plurality of pivoting drive wheel assemblies comprises:
a) a suspension assembly operatively coupling the pivoting drive wheel assembly to the 3D structural frame;
b) a tire operatively coupled to an electric drive motor;
c) a pivot body operatively coupling the tire to the suspension assembly, the pivot body;
d) a wheel pivot axle rotatably disposed in the pivot body, the wheel pivot axle defining a pivot body axis therealong; and
e) a pivot motor operatively coupled to the tire via the wheel pivot axle, wherein operation of the pivot motor enables the tire to rotate about the pivot body axis.

4. The apparatus as set forth in claim 3, wherein the suspension assembly comprises:
a plurality of suspension arms to form a parallelogram structure; and
b) a damper disposed within the parallelogram structure.

5. The apparatus as set forth in claim 3, wherein the pivot motor is configured to rotate the wheel pivot axle approximately 90° between a first position and a second position, wherein rotation of the tire moves the apparatus circumferentially around the cylindrical object when the wheel pivot axle is in the first position, and wherein rotation of the tire moves the apparatus axially on the cylindrical object along a longitudinal axis thereof when the wheel pivot axle is in the second position.

6. The apparatus as set forth in claim 1, wherein the clamping arm assembly comprises:
a) at least one actuator arm pivotally attached to the 3D structural frame, wherein each of the at least one actuator arm comprises one of the upper and lower vertices of the 3D structural frame; and
b) a servo actuator operatively coupled between the at least one actuator arm and the 3D structural frame, wherein the servo actuator can move the at least one actuator arm from an open position where the opening can receive the cylindrical object to a closed position where the plurality of pivoting drive wheel assemblies retain and engage the cylindrical object.

7. The apparatus as set forth in claim 1, wherein the cutting and fastening assembly comprises:
a) a cutting rail servo actuator configured to rotate the cutting and fastening assembly towards and away from the cylindrical object;
b) a cutting head assembly further comprising a cutting block head configured to move along a linear guide;
c) a rolled material feed mechanism configured to dispense the rolled material towards the cylindrical object;
d) a fastener gun disposed on the cutting block head, the fastener gun configured to fasten dispensed rolled material to the cylindrical object; and
e) a cutting wheel assembly disposed on the cutting block head, the cutting wheel assembly configured to cut the dispensed rolled material from the roll after the dispensed rolled material is fastened to the cylindrical object.

8. The apparatus as set forth in claim 7, wherein the cutting and fastening assembly further comprises a lead screw configured to move the cutting block head along the linear guide.

9. The apparatus as set forth in claim 7, wherein the rolled material feed mechanism further comprises:
a) a material guide configured to guide the rolled material from the roll towards the cylindrical object; and
b) material feed wheels driven by a material feed motor, the material feed wheels configured to contact and move the rolled material through the material guide.

10. The apparatus as set forth in claim 7, wherein the cutting wheel assembly comprises:
a) a cutting wheel operatively attached to a cutting wheel arm, the cutting wheel arm rotatably attached to the cutting head block;
b) a cutting backing plate disposed on the cutting and fastening assembly; and
c) a cutting wheel servo operatively coupled to the cutting wheel arm whereby operation of the cutting wheel servo moves the cutting wheel towards and away from the cutting backing plate.

11. The apparatus as set forth in claim 1, wherein the electronics assembly comprises:
a) a computer operatively coupled to each of:
i) the plurality of pivoting drive wheel assemblies,
ii) the clamping arm assembly, and
iii) the cutting and fastening assembly;
b) at least one battery operatively powering each of:
i) the computer,
ii) the plurality of pivoting drive wheel assemblies,
iii) the clamping arm assembly, and
iv) the cutting and fastening assembly.

12. The apparatus as set forth in claim 11, wherein the electronics assembly further comprises a radio modem operatively coupled to the computer, the radio modem configured to wirelessly receive command signals transmitted from a ground station controller configured to wirelessly transmit the command signals.

13. A method for wrapping rolled material on a cylindrical object, the method comprising:
a) placing an apparatus on the cylindrical object, the apparatus comprising:
i) a three-dimensional (“3D”) structural frame comprising upper and lower vertices, the 3D structural frame defining an opening disposed therein, the opening configured to receive the cylindrical object, the 3D structural frame further configured to hold a roll of the rolled material thereon,
ii) a plurality of pivoting drive wheel assemblies, wherein a pivoting drive wheel assembly is disposed near each of the upper and lower vertices,
iii) the 3D structural frame further comprising a clamping arm assembly configured to retain and engage the cylindrical object with the plurality of pivoting drive wheel assemblies,
iv) a cutting and fastening assembly linearly coupled to the 3D structural frame, the cutting and fastening assembly configured to dispense the rolled material from the roll, to fasten the dispensed rolled material to the cylindrical object, and to cut the dispensed rolled material from the roll;
b) closing the clamping arm assembly to retain and engage the cylindrical object with the plurality of pivoting drive wheel assemblies;
c) loading the roll of rolled material onto the apparatus;
d) rotating all of the plurality of pivoting drive wheel assemblies for axial movement along the cylindrical object;
e) moving the apparatus along the cylindrical object to a predetermined position;
f) rotating all of the plurality of pivoting drive wheel assemblies for circumferential movement around the cylindrical object;
g) moving the cutting and fastening assembly towards the cylindrical object and dispensing a loose end of the rolled material from the roll towards the cylindrical object;
h) fastening the loose end of the rolled material to the cylindrical object;
i) moving the apparatus around the cylindrical object and dispensing the rolled material to wrap the cylindrical object a predetermined number of times with the rolled material; and
j) simultaneously cutting the dispensed rolled material to produce a trailing loose end thereof and fastening the trailing loose end of the dispensed rolled material to the cylindrical object.
